(19) United States
(12) Patent Application Publication
(10) Pub. No.: US 2010/0043037 A1
(43) Pub. Date: Feb. 18, 2010

(54) SUBSCIRPTION VIDEO PACKAGE PROMOTION

(75) Inventors: Syed Zafar BEYABANI, Irving, TX (US); Ruchir RODRIGUES, Irving, TX (US); Shafiq KASSAM, Lewisville, TX (US)

Correspondence Address: VERIZON;PATENT MANAGEMENT GROUP, 1320 North Court House Road, 9th Floor, ARLINGTON, VA, 22201-2909, US

(73) Assignee: VERIZON DATA SERVICES LLC, Temple Terrace, FL (US)

(21) Appl. No.: 12/193,340

(22) Filed: Aug. 18, 2008

(51) Int. Cl. H04N 7/173

(52) U.S. Cl. 725/100; 725/87

(57) ABSTRACT

A device receives one or more of demand information, event information, past order information, or demographic information associated with a subscription video package, and determines a subscription video package advertisement based on one or more of the demand information, the event information, the past order information, or the demographic information. The device also provides, to one or more of a set-top box (STB) or a user device, the subscription video package advertisement for display, and receives, from one or more of the set-top box (STB) or the user device and in response to the subscription video package advertisement, a request for the subscription video package. The device further enables one or more of the set-top box (STB) or the user device to receive the subscription video package for display.

### BACKGROUND

Video on Demand (VOD) (also known as television (TV)-based VOD, on-demand television, movies-on-demand, content on demand, on-demand programming, VOD on the web, VOD on cable, pay-as-you-go, Internet-on-demand video, entertainment on demand, etc.) may utilize the Internet, intranets, and/or a multitude of other networks. VOD content can be viewed using many different electronic devices, such as, telephones, personal digital assistants (PDAs), personal computers, set-top boxes (STBs), portable media devices, etc. VOD allows viewers to select video and its accompanying content, and have the video/content sent for viewing to their STB, personal computer, mobile telephone, etc. If the VOD is to be viewed on a TV, the video/content might be stored in a customer's digital video recorder (DVR). In such cases, the customer could watch the program retrieved from the DVR's hard drive. For cable television, the customer typically can watch VOD video/content directly from a network head-end.

Subscription video on demand (SVOD), referred to herein as subscription video packages, may include movie and/or programming packages associated with scheduled events. Subscription video packages may enable (e.g., for a fixed fee) subscribers to have unlimited access to movies and/or programming during a specific time period (e.g., such as a month). However, marketing every single type of subscription video package (e.g., packages targeting different ethnic segments) requires prohibitively substantial resources (e.g., time, money, manpower, etc.). Thus, to discover an un-purchased subscription video package requires the user to happen upon a channel offering the un-purchased subscription video package via a search or via a remote control input. Such a method for discovering subscription video packages is inefficient and fails to adequately promote subscription video packages.

### BRIEF DESCRIPTION OF THE DRAWINGS

FIG. 1 depicts a diagram of an exemplary network in which systems and methods described herein may be implemented;

FIG. 2 illustrates exemplary components of a set-top box (STB), a server, and/or a user device of the network depicted in FIG. 1;

FIG. 3 depicts a diagram of an exemplary portion of the network illustrated in FIG. 1;

FIGS. 4-7 illustrate diagrams of exemplary user interfaces capable of being generated by the STB, the server, and/or the user device of the network depicted in FIG. 1;

FIG. 8 illustrates a diagram of a portion of an exemplary database capable of being provided in and/or managed by the server of the network illustrated in FIG. 1;

FIG. 9 depicts a diagram of exemplary functional components of the server of the network depicted in FIG. 1; and

FIGS. 10 and 11 illustrate flow charts of an exemplary process according to implementations described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Systems and/or methods described herein may enable companies (e.g., companies providing subscription video packages) to promote subscription video packages (e.g., SVOD) based on various information (e.g., subscription video package demand information, demographic information, event information, past order information, etc.) to subscribers. The systems and/or methods may provide feedback so that the companies may promote desired subscription video packages to the appropriate users. In one implementation, for example, the systems and/or methods may receive demand, event, past order, and/or demographic information associated with a subscription video package, and may determine a subscription video package advertisement based on the received information. The systems and/or methods may provide the subscription video package advertisement to a set-top box (STB) and/or user device for display, and may receive, from the STB and/or user device, a request for the subscription video package based on the subscription video package advertisement. The systems and/or methods may provide the requested subscription video package to the STB and/or user device for display and/or storage.

A “subscription video package,” as the term is used herein, is to be broadly construed to include, for example, SVOD, TV-based VOD, on-demand television, movies-on-demand, content on demand, on-demand programming, VOD on the web, VOD on cable, pay-as-you-go (PAYG), all day movies, live-streaming video and on-demand streaming video, Internet-on-demand video, Internet Protocol (IP)-based video, IPTV broadcasting, Internet high definition television (HDTV), Internet video, web video, video webcasting, webcasting, broadcast Internet, switched digital video (SDV), sports on demand, application on demand, entertainment on demand, information on demand, news on demand, on-demand services, television on demand, switched-on TV, anything-on-demand, a television programming package (e.g., a sports package that may include the NBA channel, the NFL network, ESPN classic, etc.), etc.

As used herein, the terms “subscriber,” “viewer,” and/or “user” may be used interchangeably. Also, the terms “subscriber,” “viewer,” and/or “user” are intended to be broadly interpreted to include a user device, a STB, and/or a television or a user of a user device, STB, and/or television.

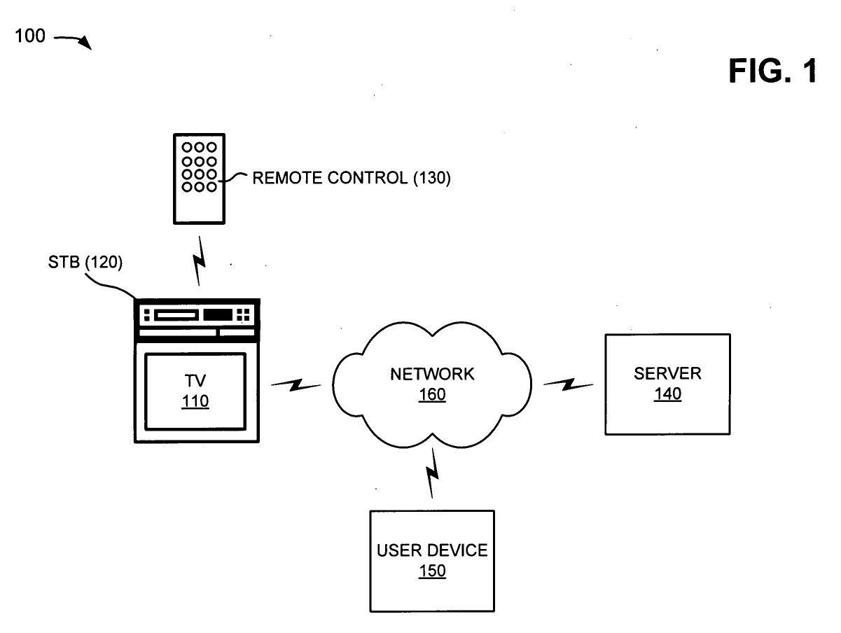

FIG. 1 is a diagram of an exemplary network 100 in which systems and methods described herein may be implemented. As illustrated, network 100 may include a television (TV) 110, a STB 120, a remote control 130, a server 140, and a user device 150 interconnected by a network 160. Components of network 100 may interconnect via wired and/or wireless connections. A single television 110, STB 120, remote control 130, server 140, user device 150, and network 160 have been illustrated in FIG. 1 for simplicity. In practice, there may be more televisions 110, STBs 120, remote controls 130, servers 140, user devices 150, and/or networks 160. Also, in some instances, one or more of the components of network 100 may perform one or more functions described as being performed by another one or more of the components of network 100.

Television 110 may include a television monitor that is capable of displaying television programming, content provided by STB 120, and/or content provided by other devices (e.g., a digital video disk (DVD) player, a video camera, etc., not shown) connected to television 110.

STB 120 may include a device that receives television programming (e.g., from server 140), and provides the television programming to television 110 or another device. STB 120 may allow a user to alter the programming provided to television 110 based on a signal (e.g., a channel up or channel down signal) from remote control 130. STB 120 may record video in a digital format to a disk drive or other memory medium within STB 120. In one exemplary implementation, STB 120 may be incorporated directly within television 110 and/or may include a digital video recorder (DVR).

Remote control 130 may include a device that allows a user to control programming and/or content displayed on television 110 via interaction with television and/or STB 120.

Server 140 may include one or more server entities, or other types of computation or communication devices, that gather, process, search, and/or provide information in a manner described herein. In one implementation, server 140 may include a computer system, an application, a cable head-end, and/or a broadcasting device capable of providing content (e.g., subscription video packages, TV programming, movies, on-demand services, live television, etc.), advertisements, instructions, and/or other information to STB 120 and/or user device 150.

User device 150 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a laptop, a personal computer, or other types of computation or communication devices, threads or processes running on these devices, and/or objects executable by these devices. In one implementation, user device 150 may include any device (e.g., an Internet Protocol (IP)-based device) that is capable of accessing server 140 via network 160.

Network 160 may include a local area network (LAN), a wide area network (WAN), a metropolitan area network (MAN), a telephone network, such as the Public Switched Telephone Network (PSTN), an intranet, the Internet, an optical fiber (or fiber optic)-based network, or a combination of networks.

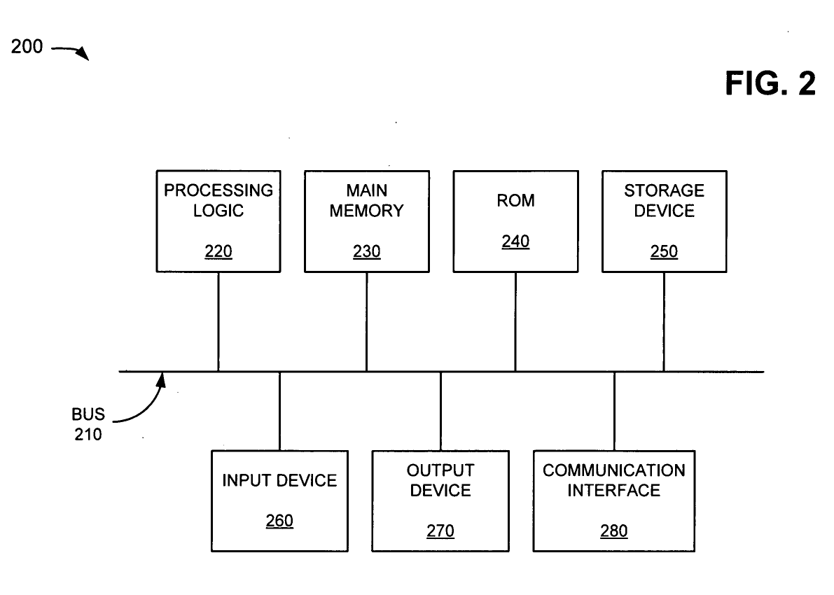

FIG. 2 is an exemplary diagram of a device 200 that may correspond to any of STB 120, server 140, and/or user device 150. As illustrated, device 200 may include a bus 210, processing logic 220, a main memory 230, a read-only memory (ROM) 240, a storage device 250, an input device 260, an output device 270, and/or a communication interface 280. Bus 210 may include a path that permits communication among the components of device 200.

Processing logic 220 may include a processor, microprocessor, or other type of processing logic that may interpret and execute instructions. Main memory 230 may include a random access memory (RAM) or another type of dynamic storage device that may store information and instructions for execution by processing logic 220. ROM 240 may include a ROM device or another type of static storage device that may store static information and/or instructions for use by processing logic 220. Storage device 250 may include a magnetic and/or optical recording medium and its corresponding drive.

Input device 260 may include a mechanism that permits an operator to input information to device 200, such as a keyboard, a mouse, a pen, a microphone, voice recognition and/or biometric mechanisms, remote control 130, etc. Output device 270 may include a mechanism that outputs information to the operator, including a display, a printer, a speaker, etc. Communication interface 280 may include any transceiver-like mechanism that enables device 200 to communicate with other devices and/or systems. For example, communication interface 280 may include mechanisms for communicating with another device or system via a network, such as network 160.

As described herein, device 200 may perform certain operations in response to processing logic 220 executing software instructions contained in a computer-readable medium, such as main memory 230. A computer-readable medium may be defined as a physical or logical memory device. The software instructions may be read into main memory 230 from another computer-readable medium, such as storage device 250, or from another device via communication interface 280. The software instructions contained in main memory 230 may cause processing logic 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows exemplary components of device 200, in other implementations, device 200 may contain fewer, different, or additional components than depicted in FIG. 2. In still other implementations, one or more components of device 200 may perform one or more other tasks described as being performed by one or more other components of device 200.

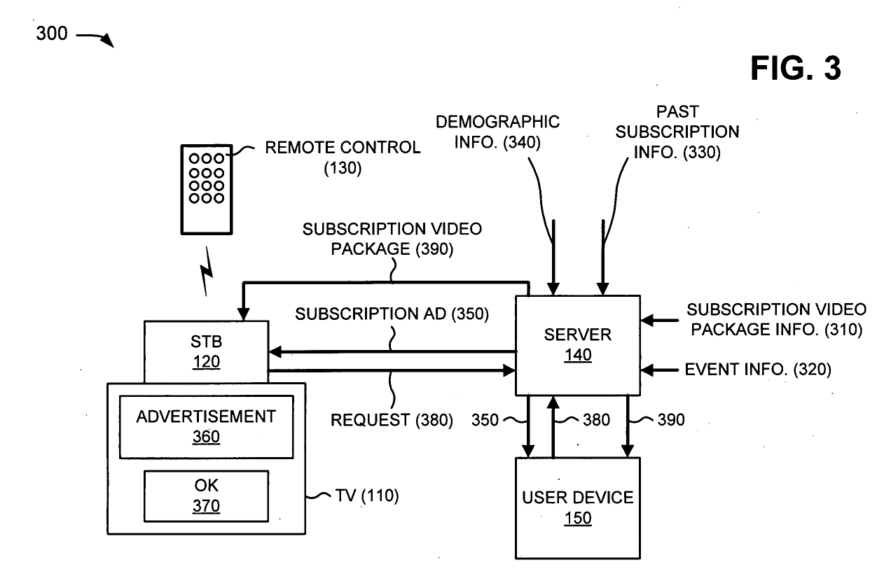

FIG. 3 depicts a diagram of an exemplary portion 300 of network 100. As illustrated, exemplary network portion 300 may include television 110, STB 120, remote control 130, server 140, and user device 150. Television 110, STB 120, remote control 130, server 140, and user device 150 may include the features described above in connection with, for example, FIG. 1.

As further shown in FIG. 3, server 140 may receive (e.g., from users and other sources) subscription video package information 310, event information 320, past subscription information 330, and demographic information 340. Subscription video package information 310 may include information associated with one or more subscription video packages. For example, subscription video package information 310 may include user demand (e.g., a number of orders) for one or more subscription video packages, programming associated with one or more subscription video packages, content associated with one or more subscription video packages, demographics associated with one or more subscription video packages, etc. Event information 320 may include information associated with events that may peak interest in one or more subscription video packages (e.g., Vietnamese subscription video packages may peak during the Vietnamese New Year, Tet Nguyen Dan). For example, event information 320 may include ethnic festivals, holidays, etc.; sporting events; entertainment events (e.g., most popular movies playing in movie theaters); historical events (e.g., July Fourth); etc. Past subscription information 330 may include past order information, associated with one or more one or more subscription video packages, by users capable of purchasing subscription video packages from server 140. For example, past subscription information 330 may include numbers and types of subscription video packages ordered by users in the past. Demographic information 340 may include demographics (e.g., race, age, income, disabilities, mobility (in terms of travel time to work or number of vehicles available), educational attainment, home ownership, employment status, location, etc.) associated with users capable of purchasing subscription video packages from server 140.

Server 140 may use subscription video package information 310, event information 320, past subscription information 330, and/or demographic information 340 to determine one or more advertisements for one or more subscription video packages. For example, in one implementation, server 140 may determine an advertisement for the most-demanded subscription video packages based on subscription video package information 310 (e.g., based on user demand for one or more subscription video packages), and may provide the advertisement to all users. Alternatively and/or additionally, server 140 may provide the advertisement (e.g., for display via STB 120) to certain demographic areas based on demographic information 340. For example, server 140 may determine that the advertisement is pertinent to a certain age group, and may provide the advertisement (e.g., for display via STB 120) to the certain age group.

In another implementation, server 140 may use past subscription information 330 to provide a weighted predictor (e.g., a weight threshold) for a generated advertisement. For example, if a first user previously ordered a subscription video package (e.g., as provided by past subscription information 330) associated with the advertisement, and a second user did not order the subscription video package (e.g., as provided by past subscription information 330), server 140 may assign a greater weight to the first user than a weight assigned to the second user. Server 140 may provide the advertisement to users (e.g., may target certain users) assigned weights exceeding a certain threshold. In other implementations, server 140 may utilize a different weighting methodology based on past subscription information 330.

In still another implementation, server 140 may determine an advertisement for subscription video packages associated with an event, based on event information 320, and may provide the advertisement to users who may be interested in the event. For example, if event information 320 indicates that St. Andrew's Day (a Polish holiday) is approaching, server 140 may generate an advertisement for subscription video packages associated with Polish content, and may provide the advertisement to Polish users (e.g., as identified by demographic information 340). In one implementation, event information 320 may indicate an uptick or spike in demand for a particular subscription video package relating to an event (e.g., St. Andrew's Day), and the uptick/spike in demand for the particular package may trigger targeted advertising aimed at those users (e.g., Polish users) most likely to be interested in the particular subscription video package. For example, the uptick/spike in demand for the particular subscription video package may trigger a commensurate uptick in advertising provided specifically to those users who will most likely subscribe to the particular package.

As further shown in FIG. 3, server 140 may broadcast a subscription advertisement (e.g., an advertisement associated with one or more subscription video packages), as indicated by reference number 350, on television 110, via STB 120, and/or on user device 150. For example, STB 120 may receive subscription advertisement 350 from server 140, and may display an advertisement 360 and a selection mechanism 370 on television 110. Advertisement 360 may include an advertisement (or promotion) associated with one or more subscription video packages. For example, advertisement 360 may include information, such as “Choose from one or more of the following premium movie channels.” Selection mechanism 370 may include a button (e.g., an “OK” button as illustrated in FIG. 3), an icon, a link, and/or other similar selection mechanisms. In one example, selection mechanism 370 may include information, such as “Select one or more subscription video packages, and then select OK.” If a viewer of television 110 selects selection mechanism 370 (e.g., via remote control 130), STB 120 may provide a request 380 to server 140. Alternatively and/or additionally, user device 150 may provide request 380 to server 140. In one implementation, request 380 may include a request for one or more of the subscription video packages associated with advertisement 360, information (e.g., a serial number, numbers, letters, etc.) identifying STB 120 to server 140, etc. Request 380 may provide feedback so that the companies may promote desired subscription video packages to the appropriate users.

Server 140 may receive request 380, and may confirm that the requested one or more subscription video packages associated with advertisement 360 are available. For example, server 140 may determine whether the requested one or more subscription video packages associated with advertisement 360 have expired, have already been purchased by the user associated with STB 120 and/or user device 150, etc. As shown in FIG. 3, if server 140 determines that the requested one or more subscription video packages associated with advertisement 360 are available, server 140 may provide a subscription video package 390 to STB 120 (e.g., for viewing on television 110 and/or storage via a DVR) and/or to user device 150 (e.g., for viewing and/or storage), and/or may enable STB 120 and/or user device 150 to receive subscription video package 390. Subscription video package 390 may include any of the items described above in connection with the term “subscription video package.” A user associated with STB 120 and/or user device 150 may be able to view subscription video package 390 via television 110 and/or user device 150.

Such an arrangement, as depicted in FIG. 3, may enable companies (e.g., companies providing subscription video packages) to promote subscription video packages (e.g., SVOD), based on various information (e.g., subscription video package information 310, event information 320, past subscription information 330, demographic information 340, etc.), to subscribers. The arrangement may provide feedback so that the companies may promote desired subscription video packages to the appropriate subscribers.

Although FIG. 3 shows exemplary components of network portion 300, in other implementations, network portion 300 may contain fewer, different, or additional components than depicted in FIG. 3. In still other implementations, one or more components of network portion 300 may perform one or more other tasks described as being performed by one or more other components of network portion 300.

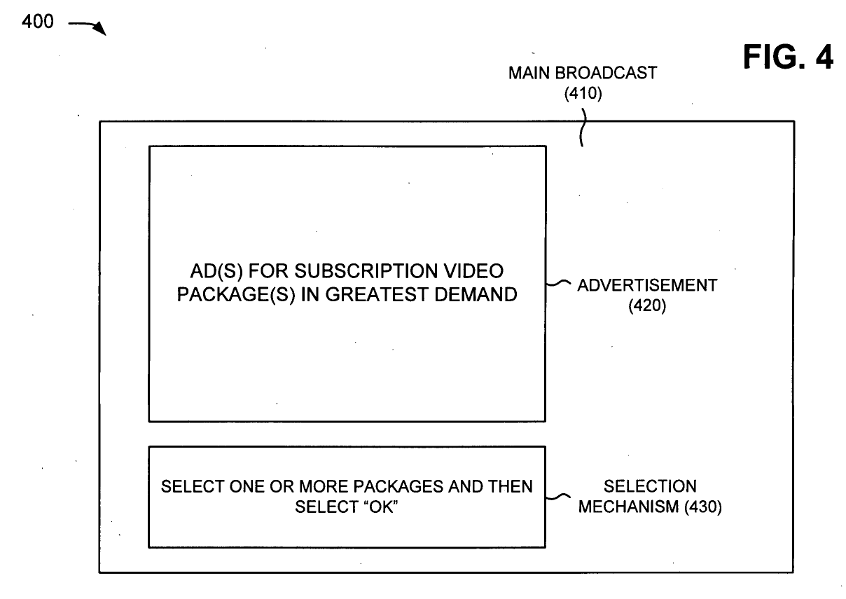

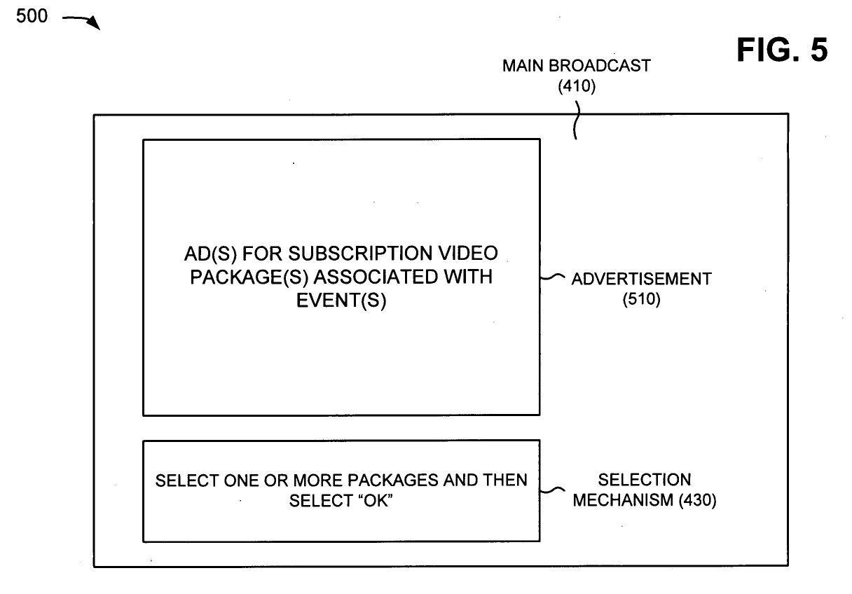

FIG. 4 illustrates a diagram of an exemplary user interface 400 capable of being generated by STB 120, server 140, and/or user device 150 (e.g., and displayed via television 110 and/or user device 150). The user interface depicted in FIG. 4, and each of the user interfaces depicted in FIGS. 5-7 and described below (collectively referred to as “the user interfaces”), may include a graphical user interface (GUI) or a non-graphical user interface, such as a text-based interface. The user interfaces may provide information to users via a customized interface (e.g., a proprietary interface) and/or other types of interfaces (e.g., a browser-based interface, a television interface, etc.). The user interfaces may receive user inputs via one or more input devices (e.g., input device 260), may be user-configurable (e.g., a user may change the size of the user interfaces, information displayed in the user interfaces, color schemes used by the user interfaces, positions of text, images, icons, windows, etc., in the user interfaces, etc.), and/or may not be user-configurable. The user interfaces may be displayed to a user via one or more output devices (e.g., output device 270).

As illustrated in FIG. 4, user interface 400 may include a main broadcast 410, an advertisement 420, and/or a selection mechanism 430. Information associated with user interface 400 may be selected by a user of STB 120 (e.g., via remote control 130) and/or user device 150.

Main broadcast 410 may include a television program being broadcast via STB 120 on television 110 (or via user device 150), a television commercial, a program guide provided by STB 120 and/or user device 150, video-on-demand provided by STB 120 and/or user device 150, etc.

Advertisement 420 may include an advertisement (e.g. subscription advertisement 350) associated with a subscription video package. Advertisement 420 may include information, such as one or more advertisements for subscription video packages in greatest demand (e.g., as provided by subscription video package information 310). For example, if premium movie channel subscription video packages are in demand, advertisement 420 may include information (e.g., prices, features, etc.) associated with such premium movie channels. In one implementation, advertisement 420 may include an advertisement associated with or otherwise related to content provided by main broadcast 410. For example, if main broadcast 410 provides financial information (e.g., a television program discussing the stock market), advertisement 420 may include an advertisement associated with financial subscription video packages. In other implementations, advertisement 420 may include an advertisement that is not associated with content provided by main broadcast 410.

Selection mechanism 430 may include a button, an icon, a link, and/or other similar selection mechanisms (e.g., instructions). For example, selection mechanism 430 may include information, such as “Select one or more packages and then select OK.” If a viewer of television 110 (and/or user device 150) selects selection mechanism 430 or follows instructions provided by selection mechanism 430 (e.g., via remote control 130), STB 120 and/or user device 150 may provide request 380 to server 140.

Although user interface 400 depicts a variety of information, in other implementations, user interface 400 may depict fewer, different, or additional information than depicted in FIG. 4. For example, although advertisement 420 and selection mechanism 430 are depicted as overlaying a major portion of main broadcast 410, in some implementations, advertisement 420 and/or selection mechanism 430 may overlay a smaller portion of main broadcast 410 (e.g., advertisement 420 and/or selection mechanism 430 may be provided in a side bar area on television 110). In still other implementations, advertisement 420 and/or selection mechanism 430 may be provided with other commercials.

FIG. 5 depicts a diagram of an exemplary user interface 500 capable of being generated by STB 120, server 140, and/or user device 150 (e.g., and displayed via television 110 and/or user device 150). As illustrated, user interface 500 may include main broadcast 410, an advertisement 510, and/or selection mechanism 430. Information associated with user interface 500 may be selected by a user of STB 120 (e.g., via remote control 130) and/or user device 150. Main broadcast 410 and selection mechanism 430 may include the features described above in connection with, for example, FIG. 4.

Advertisement 510 may include an advertisement (e.g. subscription advertisement 350) associated with a subscription video package. Advertisement 510 may include information, such as one or more advertisements for subscription video packages associated with events (e.g., as provided by event information 320). For example, if event information 320 indicates that St. Patrick's Day (an Irish holiday) is approaching, advertisement 510 may include information promoting Irish subscription video packages (e.g., to Irish users and/or to all users). In another example, if event information 320 indicates that a popular action movie is currently in theaters, advertisement 510 may include information promoting action movie subscription video packages (e.g., to certain users and/or to all users). In one implementation, advertisement 510 may include an advertisement associated with or otherwise related to content provided by main broadcast 410. In other implementations, advertisement 510 may include an advertisement that is not associated with content provided by main broadcast 410.

Although user interface 500 depicts a variety of information, in other implementations, user interface 500 may depict fewer, different, or additional information than depicted in FIG. 5. For example, although advertisement 510 and selection mechanism 430 are depicted as overlaying a major portion of main broadcast 410, in some implementations, advertisement 510 and/or selection mechanism 430 may overlay a smaller portion of main broadcast 410 (e.g., advertisement 510 and/or selection mechanism 430 may be provided in a side bar area on television 11 0). In still other implementations, advertisement 510 and/or selection mechanism 430 may be provided with other commercials.

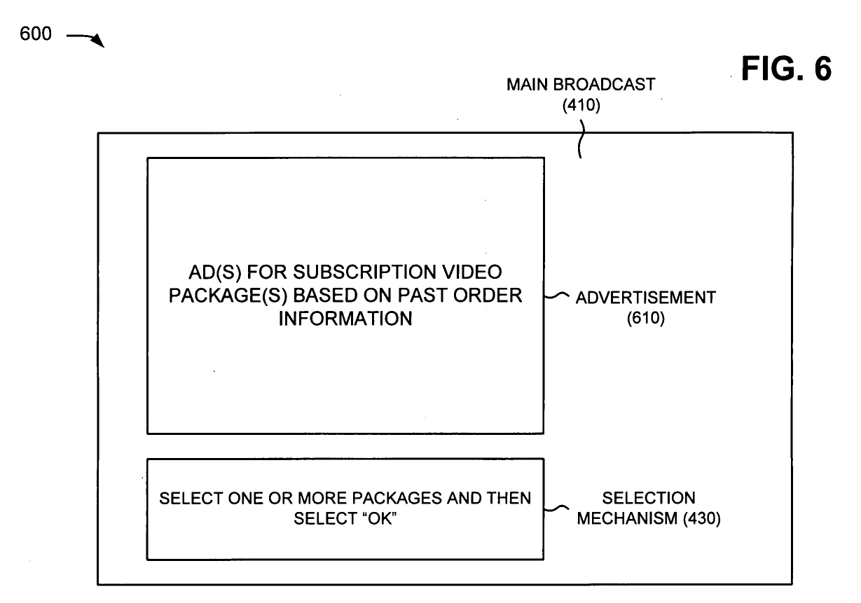

FIG. 6 depicts a diagram of an exemplary user interface 600 capable of being generated by STB 120, server 140, and/or user device 150 (e.g., and displayed via television 110 and/or user device 150). As illustrated, user interface 600 may include main broadcast 410, an advertisement 610, and/or selection mechanism 430. Information associated with user interface 600 may be selected by a user of STB 120 (e.g., via remote control 130) and/or user device 150. Main broadcast 410 and selection mechanism 430 may include the features described above in connection with, for example, FIG. 4.

Advertisement 610 may include an advertisement (e.g. subscription advertisement 350) associated with a subscription video package. Advertisement 610 may include information, such as one or more advertisements for subscription video packages determined based on past order information (e.g., as provided by past subscription information 330). For example, if past subscription information 330 indicates that particular users subscribe to football games on Sundays, advertisement 610 may include information promoting football related subscription video packages, and may be provided to the particular users and/or to all users. In another example, if past subscription information 330 indicates that particular users frequently subscribe to movies, advertisement 610 may include information promoting unlimited movie related subscription video packages (e.g., to certain users and/or to all users). In one implementation, advertisement 610 may include an advertisement associated with or otherwise related to content provided by main broadcast 410. In other implementations, advertisement 610 may include an advertisement that is not associated with content provided by main broadcast 410.

Although user interface 600 depicts a variety of information, in other implementations, user interface 600 may depict fewer, different, or additional information than depicted in FIG. 6. For example, although advertisement 610 and selection mechanism 430 are depicted as overlaying a major portion of main broadcast 410, in some implementations, advertisement 610 and/or selection mechanism 430 may overlay a smaller portion of main broadcast 410 (e.g., advertisement 610 and/or selection mechanism 430 may be provided in a side bar area on television 110). In still other implementations, advertisement 610 and/or selection mechanism 430 may be provided with other commercials.

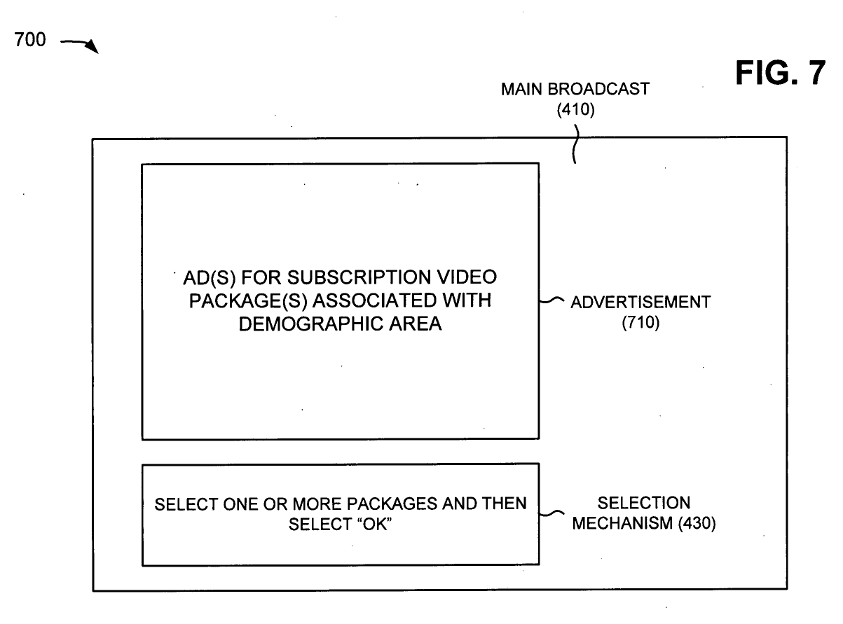

FIG. 7 depicts a diagram of an exemplary user interface 700 capable of being generated by STB 120, server 140, and/or user device 150 (e.g., and displayed via television 110 and/or user device 150). As illustrated, user interface 700 may include main broadcast 410, an advertisement 710, and/or selection mechanism 430. Information associated with user interface 700 may be selected by a user of STB 120 (e.g., via remote control 130) and/or user device 150. Main broadcast 410 and selection mechanism 430 may include the features described above in connection with, for example, FIG. 4.

Advertisement 710 may include an advertisement (e.g. subscription advertisement 350) associated with a subscription video package. Advertisement 710 may include information, such as one or more advertisements for subscription video packages associated with a demographic area (e.g., as provided by demographic information 340). For example, if demographic information 340 indicates that particular users are Japanese, advertisement 710 may include information promoting Japanese related subscription video packages, and may be provided to the particular users and/or to all users. In another example, if demographic information 340 indicates that particular users are more than sixty-five years in age, advertisement 710 may include information promoting subscription video packages related to retirement (e.g., related to vacations, money management, etc.). In one implementation, advertisement 710 may include an advertisement associated with or otherwise related to content provided by main broadcast 410. In other implementations, advertisement 710 may include an advertisement that is not associated with content provided by main broadcast 410.

Although user interface 700 depicts a variety of information, in other implementations, user interface 700 may depict fewer, different, or additional information than depicted in FIG. 7. For example, although advertisement 710 and selection mechanism 430 are depicted as overlaying a major portion of main broadcast 410, in some implementations, advertisement 710 and/or selection mechanism 430 may overlay a smaller portion of main broadcast 410 (e.g., advertisement 710 and/or selection mechanism 430 may be provided in a side bar area on television 110). In still other implementations, advertisement 710 and/or selection mechanism 430 may be provided with other commercials.

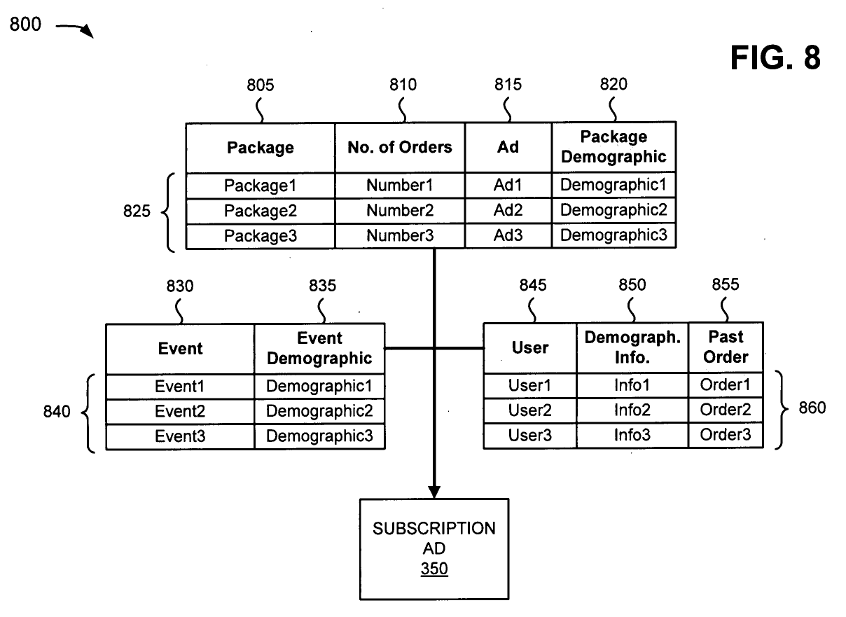

FIG. 8 illustrates a diagram of a portion 800 of an exemplary database capable of being provided in and/or managed by server 140. As illustrated, database portion 800 may include a variety of information associated with subscription video packages and/or users. For example, database portion 800 may include a first table that includes a package field 805, a number of orders field 810, an advertisement field 815, a package demographic field 820, and/or a variety of entries 825 associated with fields 805-820.

Package field 805 may include information associated with subscription video packages (e.g., subscription video package information 310), such as content, costs, features, services, etc. For example, package field 805 may include entries for “Package1,” “Package2,” Package3,” etc.

Number of orders field 810 may include entries 825 providing numbers of orders associated with the subscription video packages provided in package field 805. For example, number of orders field 810 may indicate that “Package1” (e.g., provided in package field 805) was ordered a number (e.g., “Number1”) of times by users, that “Package2” (e.g., provided in package field 805) was ordered a number (e.g., “Number2”) of times by users, and that “Package3” (e.g., provided in package field 805) was ordered a number (e.g., “Number3”) of times by users.

Advertisement field 815 may include entries 825 providing advertisements (e.g., subscription advertisement 350) associated with the subscription video packages provided in package field 805. For example, advertisement field 815 may indicate that “Package1” (e.g., provided in package field 805) is associated with an advertisement (e.g., “Ad1”), that “Package2” (e.g., provided in package field 805) is associated with an advertisement (e.g., “Ad2”), and that “Package3” (e.g., provided in package field 805) is associated with an advertisement (e.g., “Ad3”). More than one advertisement may be identified for a particular package provided in advertisement field 815.

Package demographic field 820 may include entries 825 providing demographic information (e.g., demographic information 340) associated with the subscription video packages provided in package field 805. For example, package demographic field 820 may indicate that “Package1” (e.g., provided in package field 805) is associated with a demographic (e.g., “Demographic1”), that “Package2” (e.g., provided in package field 805) is associated with a demographic (e.g., “Demographic2”), and that “Package3” (e.g., provided in package field 805) is associated with a demographic (e.g., “Demographic3”). In one example, if the subscription video package provided in package field 805 relates to movies in Japanese, package demographic field 820 may indicate that such a subscription video package may be of interest to Japanese users. More than one advertisement may be identified for a particular package provided in package demographic field 820.

As further shown in FIG. 8, database portion 800 may include a second table that includes an event field 830, an event demographic field 835, and/or a variety of entries 840 associated with fields 830 and 835.

Event field 830 may include information associated with events (e.g., event information 320), such as ethnic festivals, holidays, sporting events, entertainment events, historical events, etc. For example, event field 830 may include entries for “Event1,” “Event2,” Event3,” etc.

Event demographic field 835 may include entries 840 providing demographic information (e.g., demographic information 340) associated with the events provided in event field 830. For example, event demographic field 835 may indicate that “Event1” (e.g., provided in event field 830) is associated with a demographic (e.g., “Demographic1”), that “Event2” (e.g., provided in event field 830) is associated with a demographic (e.g., “Demographic2”), and that “Event3” (e.g., provided in event field 830) is associated with a demographic (e.g., “Demographic3”). In one example, if the event provided in event field 830 relates to a Vietnamese holiday, event demographic field 835 may indicate that such an event may be of interest to Vietnamese users.

As still further shown in FIG. 8, database portion 800 may include a third table that includes a user field 845, a demographic information field 850, a past order field 855, and/or a variety of entries 860 associated with fields 845-855.

User field 845 may include information associated with users of services (e.g., subscription video packages) provided by server 140, such as user identification, user name, user address, etc. For example, user field 845 may include entries for “User1,” “User2,” User3,” etc. In one example, each entry in user field 845 may include an identifier for a user (e.g., an account number, a user name and/or password, etc.), the user's name, user contact information (e.g., address, telephone number, email address, etc.), etc.

Demographic information field 850 may include entries 860 providing demographic information (e.g., demographic information 340, such as age, ethnicity, etc.) associated with the users provided in user field 845. For example, demographic information field 850 may indicate that “User1” (e.g., provided in user field 845) is associated with demographic information (e.g., “Info1”), that “User2” (e.g., provided in user field 845) is associated with demographic information (e.g., “Info2”), and that “User3” (e.g., provided in user field 845) is associated with demographic information (e.g., “Info3”).

Past order field 855 may include entries 860 providing past order information (e.g., past subscription information 330) associated with the users provided in user field 845. For example, past order field 855 may indicate that “User1” (e.g., provided in user field 845) is associated with past order information (e.g., “Order1”), that “User2” (e.g., provided in user field 845) is associated with past order information (e.g., “Order2”), and that “User3” (e.g., provided in user field 845) is associated with past order information (e.g., “Order3”).

As also shown in FIG. 8, the information provided in database portion 800 may be utilized (e.g., by server 140) to determine subscription advertisement 350 provided by server 140 to STB 120 and/or user device 150. For example, server 140 may determine that a subscription video package (e.g., “Package1” provided in package field 805) is appropriate for a particular user (e.g., “User1” provided in user field 845) based on the information provided in database portion 800. Accordingly, server 140 may provide a particular advertisement (e.g., “Ad1” provided in advertisement field 815), as subscription advertisement 350, to STB 120 and/or user device 150 associated with “User1.”

Although FIG. 8 shows exemplary information that may be provided in database portion 800, in other implementations, database portion 800 may contain fewer, different, or additional information than depicted in FIG. 8.

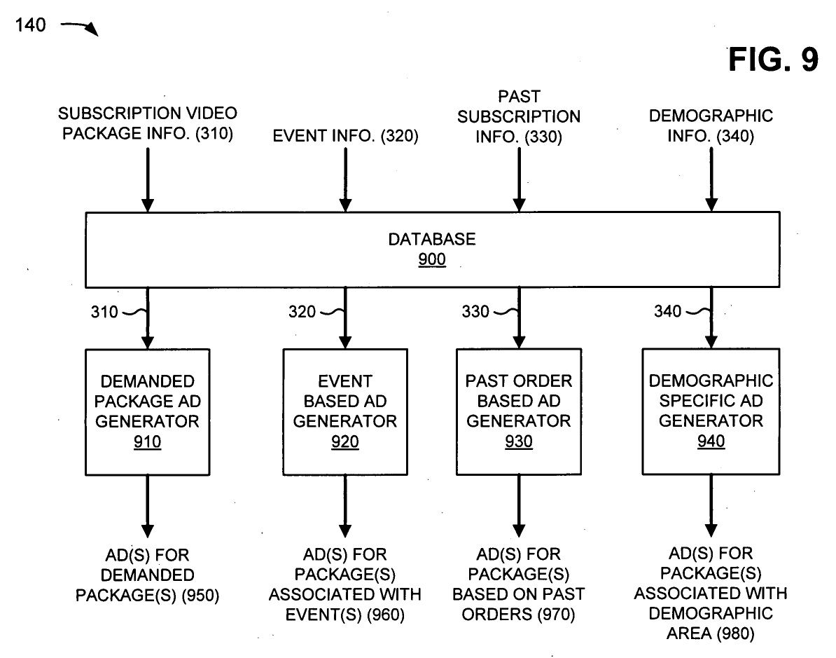

FIG. 9 depicts a diagram of exemplary functional components of server 140. As illustrated, server 140 may include a database 900, demanded package ad generator logic 910, event based ad generator logic 920, past order based ad generator logic 930, and/or demographic specific ad generator logic 940. The functions described in FIG. 9 may be performed by one or more of the exemplary components of device 200 depicted in FIG. 2.

Database 900 may include a storage device (e.g., main memory 230, ROM 240, storage device 250, etc.) that may store information received by server 140. In one implementation, database 900 may store information described above in connection with database portion 800 (FIG. 8). For example, as shown in FIG. 9, database 900 may receive (e.g., from users and other sources) and store subscription video package information 310, event information 320, past subscription information 330, and/or demographic information 340.

Demanded package ad generator logic 910 may include any hardware, software, or combination of hardware and software based logic (e.g., processing logic 220) that receives subscription video package information 310 from database 900, and determines one or more advertisements for one or more demanded subscription video packages, as indicated by reference number 950 (e.g., as “ad(s) for demanded package(s)”). In one implementation, demanded package ad generator logic 910 may determine which subscription video packages are in demand (e.g., based on subscription video package information 310), and may associate appropriate advertisements with such demanded subscription video packages. Demanded package ad generator logic 910 may provide ad(s) for demanded package(s) 950 (e.g., advertisement 420) to appropriate users (e.g., via STBs 120 and/or user devices 150 associated with the users).

Event based ad generator logic 920 may include any hardware, software, or combination of hardware and software based logic (e.g., processing logic 220) that receives event information 320 from database 900, and determines one or more advertisements for one or more subscription video packages associated with one or more events, as indicated by reference number 960 (e.g., as “ad(s) for package(s) associated with event(s)”). In one implementation, event based ad generator logic 920 may determine which subscription video packages are associated with events (e.g., based on event information 320), and may associate appropriate advertisements with such subscription video packages. Event based ad generator logic 920 may provide ad(s) for package(s) associated with event(s) 960 (e.g., advertisement 510) to appropriate users (e.g., via STBs 120 and/or user devices 150 associated with the users).

Past order based ad generator logic 930 may include any hardware, software, or combination of hardware and software based logic (e.g., processing logic 220) that receives past subscription information 330 from database 900, and determines one or more advertisements for one or more subscription video packages based on past subscription information 330, as indicated by reference number 970 (e.g., as “ad(s) for package(s) based on past orders”). In one implementation, past order based ad generator logic 930 may determine which subscription video packages may be associated with certain users (e.g., based on past subscription information 330), and may associate appropriate advertisements with such subscription video packages. Past order based ad generator logic 930 may provide ad(s) for package(s) based on past orders 970 (e.g., advertisement 610) to appropriate users (e.g., via STBs 120 and/or user devices 150 associated with the users).

Demographic specific ad generator logic 940 may include any hardware, software, or combination of hardware and software based logic (e.g., processing logic 220) that receives demographic information 340 from database 900, and determines one or more advertisements for one or more subscription video packages based on demographic information 340, as indicated by reference number 980 (e.g., as “ad(s) for package(s) associated with demographic area”). In one implementation, demographic specific ad generator logic 940 may determine which subscription video packages may be appropriate for certain users (e.g., based on demographic information 340), and may associate appropriate advertisements with such subscription video packages. Demographic specific ad generator logic 940 may provide ad(s) for package(s) associated with demographic area 980 (e.g., advertisement 710) to appropriate users (e.g., via STBs 120 and/or user devices 150 associated with the users).

Although FIG. 9 shows exemplary functional components of server 140, in other implementations, server 140 may contain fewer, different, or additional functional components than depicted in FIG. 9. In still other implementations, one or more functional components of server 140 may perform one or more other tasks described as being performed by one or more other functional components of server 140.

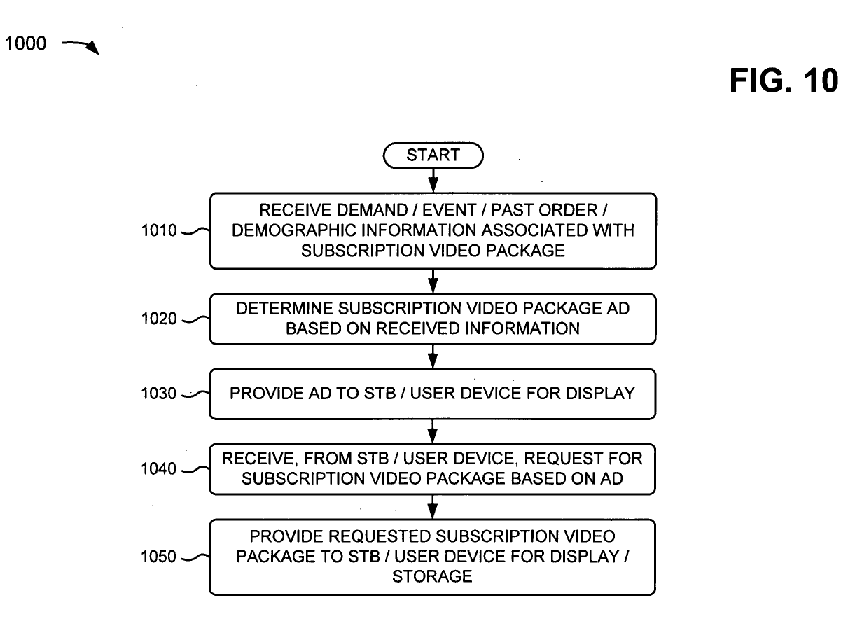

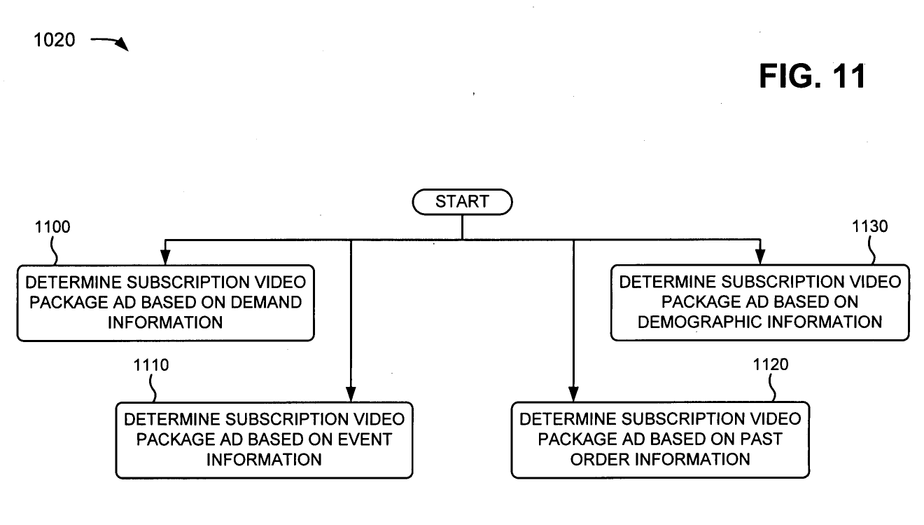

FIGS. 10 and 11 illustrate flow charts of an exemplary process 1000 for enabling companies to promote subscription video packages, based on various information, to subscribers, according to implementations described herein. In one implementation, process 1000 may be performed by server 140. In another implementation, some or all of process 1000 may be performed by another device or group of devices, including or excluding server 140.

As illustrated in FIG. 10, process 1000 may begin with receipt of demand, event, past order, and/or demographic information associated with a subscription video package (block 1010), and determination of a subscription video package advertisement based on the received information (block 1020). For example, in implementations described above in connection with FIG. 3, server 140 may receive (e.g., from users and other sources) subscription video package information 310, event information 320, past subscription information 330, and demographic information 340. Subscription video package information 310 may include information associated with one or more subscription video packages. Event information 320 may include information associated with events that may peak interest in one or more subscription video packages. Past subscription information 330 may include past order information, associated with one or more one or more subscription video packages, by users capable of purchasing subscription video packages from server 140. Demographic information 340 may include demographics associated with users capable of purchasing subscription video packages from server 140. Server 140 may use subscription video package information 310, event information 320, past subscription information 330, and/or demographic information 340 to determine one or more advertisements for one or more subscription video packages.

As further shown in FIG. 10, the subscription video package advertisement may be provided to a STB and/or a user device for display (block 1030), and, in response, a request for the subscription video package may be received from the STB and/or the user device based on the subscription video package advertisement (block 1040). For example, in implementations described above in connection with FIG. 3, server 140 may broadcast a subscription advertisement (e.g., an advertisement associated with one or more subscription video packages), as indicated by reference number 350, on television 110, via STB 120, and/or on user device 150. In one example, STB 120 may receive subscription advertisement 350 from server 140, and may display advertisement 360 and selection mechanism 370 on television 110. Advertisement 360 may include an advertisement (or promotion) associated with one or more subscription video packages. If a viewer of television 110 selects selection mechanism 370 (e.g., via remote control 130), STB 120 may provide request 380 to server 140. Alternatively and/or additionally, user device 150 may provide request 380 to server 140. Request 380 may include a request for one or more of the subscription video packages associated with advertisement 360, information (e.g., a serial number, numbers, letters, etc.) identifying STB 120 to server 140, etc. Server 140 may receive request 380, and may confirm that the requested one or more subscription video packages associated with advertisement 360 are available.

Returning to FIG. 10, the requested subscription video package may be provided to the STB and/or the user device for display and/or storage (block 1050). For example, in implementations described above in connection with FIG. 3, if server 140 determines that the requested one or more subscription video packages associated with advertisement 360 are available, server 140 may provide subscription video package 390 to STB 120 (e.g., for viewing on television 110 and/or storage via a DVR) and/or to user device 150 (e.g., for viewing and/or storage). Subscription video package 390 may include any of the items described above in connection with the term “subscription video package.” A user associated with STB 120 and/or user device 150 may be able to view subscription video package 390 via television 110 and/or user device 150.

Process block 1020 may include the process blocks depicted in FIG. 11. As shown in FIG. 11, process block 1020 may include one or more of determining the subscription video package advertisement based on the demand information (block 1100), determining the subscription video package advertisement based on the event information (block 1110), determining the subscription video package advertisement based on the past order information (block 1120), or determining the subscription video package advertisement based on the demographic information (block 1130). For example, in implementations described above in connection with FIG. 3, server 140 may determine an advertisement for the most-demanded subscription video packages based on subscription video package information 310 (e.g., based on user demand for one or more subscription video packages), and may provide the advertisement to all users. Alternatively and/or additionally, server 140 may provide the advertisement (e.g., for display via STB 120) to certain demographic areas based on demographic information 340.

In another example, server 140 may use past subscription information 330 to provide a weighted predictor (e.g., a weight threshold) for a generated advertisement. For example, if a first user previously ordered a subscription video package (e.g., as provided by past subscription information 330) associated with the advertisement, and a second user did not order the subscription video package (e.g., as provided by past subscription information 330), server 140 may assign a greater weight to the first user than a weight assigned to the second user. Server 140 may provide the advertisement to users assigned weights exceeding a certain threshold.

In still another example, server 140 may determine an advertisement for the subscription video packages associated with an event, based on event information 320, and may provide the advertisement to users who may be interested in the event. For example, if event information 320 indicates that St. Andrew's Day (a Polish holiday) is approaching, server 140 may generate an advertisement for subscription video packages associated with Polish content, and may provide the advertisement to Polish users (e.g., as identified by demographic information 340).

Systems and/or methods described herein may enable companies to promote subscription video packages, based on various information, to subscribers. The systems and/or methods may provide feedback so that the companies may promote desired subscription video packages to the appropriate users. In one implementation, for example, the systems and/or methods may receive demand, event, past order, and/or demographic information associated with a subscription video package, and may determine a subscription video package advertisement based on the received information. The systems and/or methods may provide the subscription video package advertisement to a set-top box (STB) and/or user device for display, and may receive, from the STB and/or user device, a request for the subscription video package based on the subscription video package advertisement. The systems and/or methods may provide the requested subscription video package to the STB and/or user device for display and/or storage.

The foregoing description of implementations provides illustration and description, but is not intended to be exhaustive or to limit the invention to the precise form disclosed. Modifications and variations are possible in light of the above teachings or may be acquired from practice of the invention.

For example, while a series of blocks has been described with regard to FIGS. 10 and 11, the order of the blocks may be modified in other implementations. Further, non-dependent blocks may be performed in parallel.

It will be apparent that embodiments, as described herein, may be implemented in many different forms of software, firmware, and hardware in the implementations illustrated in the figures. The actual software code or specialized control hardware used to implement embodiments described herein is not limiting of the invention. Thus, the operation and behavior of the embodiments were described without reference to the specific software code--it being understood that software and control hardware may be designed to implement the embodiments based on the description herein.

Further, certain portions of the invention may be implemented as “logic” that performs one or more functions. This logic may include hardware, such as an application specific integrated circuit or a field programmable gate array, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A computing device-implemented method, comprising:
receiving one or more of demand information, event information, past order information, or demographic information associated with a subscription video package;
determining a subscription video package advertisement based on one or more of the demand information, the event information, the past order information, or the demographic information;
providing, to one or more of a set-top box (STB) or a user device, the subscription video package advertisement for display;
receiving, from one or more of the set-top box (STB) or the user device and in response to the subscription video package advertisement, a request for the subscription video package; and
enabling one or more of the set-top box (STB) or the user device to receive the subscription video package for display.

2. The computing device-implemented method of claim 1, further comprising:
providing, to one or more of the set-top box (STB) or the user device, the subscription video package for storage.

3. The computing device-implemented method of claim 1, where determining a subscription video package advertisement comprises one or more of:
determining a subscription video package advertisement, for a demanded subscription video package, based the demand information;
determining a subscription video package advertisement, for a subscription video package associated with an event, based the event information;
determining a subscription video package advertisement, for a previously ordered subscription video package, based the past order information; or
determining a subscription video package advertisement, for a subscription video package associated with a demographic area, based the demographic information.

4. The computing device-implemented method of claim 1, where the computing device comprises a server.

5. The computing device-implemented method of claim 1, where the demand information comprises one or more of:
user demand for one or more subscription video packages,
programming associated with the one or more subscription video packages,
content associated with the one or more subscription video packages, or
demographics associated with the one or more subscription video packages.

6. The computing device-implemented method of claim 1, where the event information comprises one or more of:
information associated with events that increases interest in one or more subscription video packages,
ethnic festivals,
ethnic holidays,
sporting events,
entertainment events, or
historical events.

7. The computing device-implemented method of claim 1, where the past order information comprises numbers and types of subscription video packages ordered by users in the past.

8. The computing device-implemented method of claim 1, where the demographic information comprises demographic information associated with users capable of purchasing subscription video packages.

9. The computing device-implemented method of claim 1, where the subscription video package comprises one or more of:
subscription video on-demand (SVOD),
television-based video on-demand (VOD),
on-demand television,
movies-on-demand,
content on demand,
on-demand programming,
video on-demand (VOD) on the web,
video on-demand (VOD) on cable,
pay-as-you-go (PAYG),
all day movies,
on-demand streaming video,
Internet-on-demand video,
Internet Protocol (IP)-based video,
Internet high definition television (HDTV),
webcasting,
broadcast Internet, or
a television programming package.

10. The computing device-implemented method of claim 1, further comprising:
providing the subscription video package advertisement for display to a particular demographic area based on the demographic information.

11. The computing device-implemented method of claim 1, further comprising:
determining a weight threshold associated with the subscription video package advertisement based on the past order information; and
providing the subscription video package advertisement to users assigned weights greater than the weight threshold associated with the subscription video package.

12. The computing device-implemented method of claim 1, further comprising:
providing the subscription video package advertisement for display to all users capable of receiving the subscription video package.

13. The computing device-implemented method of claim 1, further comprising:
providing the subscription video package advertisement for display to some users capable of receiving the subscription video package.

14. A computing device-implemented method, comprising:
receiving an advertisement associated with a subscription video package and determined based on one or more of demand information, event information, past order information, or demographic information associated with the subscription video package;
displaying the advertisement;
detecting a request for the subscription video package associated with the advertisement;
transmitting the request to a remote server
receiving the subscription video package from the remote server; and
displaying video associated with the subscription video package.

15. The computing device-implemented method of claim 14, where the computing device comprises one or more of a set-top box (STB) or a user device.

16. The computing device-implemented method of claim 15, where the user device comprises one or more of:
a radiotelephone;
a personal communications system (PCS) terminal;
a personal digital assistant (PDA);
a laptop; or
a personal computer.

17. A device, comprising:
a memory to store a plurality of instructions; and
a processor to execute instructions in the memory to:
receive one or more of demand information, event information, past order information, or demographic information associated with a subscription video package,
determine a subscription video package advertisement based on one or more of the demand information, the event information, the past order information, or the demographic information,
provide, to one or more of a set-top box (STB) or a user device, the subscription video package advertisement for display,
receive, from one or more of the set-top box (STB) or the user device, a request for the subscription video package, and
enable one or more of the set-top box (STB) or the user device to receive video associated with the subscription video package for display.

18. The device of claim 17, where the processor further executes instructions in the memory to:
enable one or more of the set-top box (STB) or the user device to receive video associated with the subscription video package for storage.

19. The device of claim 17, where the processor further executes instructions in the memory to one or more of:
determine a subscription video package advertisement, for a demanded subscription video package, based the demand information;
determine a subscription video package advertisement, for a subscription video package associated with an event, based the event information;
determine a subscription video package advertisement, for a previously ordered subscription video package, based the past order information; or
determine a subscription video package advertisement, for a subscription video package associated with a demographic area, based the demographic information.

20. The device of claim 17, where the processor further executes instructions in the memory to:
provide the subscription video package advertisement for display to a particular demographic area based on the demographic information.

21. The device of claim 17, where the processor further executes instructions in the memory to:
determine a weight threshold associated with the subscription video package advertisement based on the past order information; and
provide the subscription video package advertisement to users assigned weights greater than the weight threshold associated with the subscription video package.

22. The device of claim 17, where the processor further executes instructions in the memory to:
provide the subscription video package advertisement for display to all users capable of receiving the subscription video package.

23. The device of claim 17, where the processor further executes instructions in the memory to:
provide the subscription video package advertisement for display to some users capable of receiving the subscription video package.

24. A system, comprising:
a server configured to:
receive one or more of demand information, event information, past order information, or demographic information associated with a subscription video package,
determine a subscription video package advertisement based on one or more of the demand information, the event information, the past order information, or the demographic information,
provide, to a device, the subscription video package advertisement,
receive, from the device, a request for the subscription video package, and
enable the device to receive the subscription video package; and
the device configured to:
receive the subscription video package advertisement from the server,
display the subscription video package advertisement,
detect the request for the subscription video package,
transmit the request to the server,
receive the subscription video package from the server, and
display video associated with the subscription video package.

25. The system of claim 24, where the device comprises one of a set-top box (STB) or a user device.
